(19) United States
(12) Patent Application Publication
(10) Pub. No.: US 2023/0022376 A1
(43) Pub. Date: Jan. 26, 2023

(54) BOSS FOR TYPE IV COMPOSITE PRESSURE VESSELS

(71) Applicant: STEELHEAD COMPOSITES, INC., Golden, CO (US)

(72) Inventors: Michael Stewart, Wheat Ridge, CO (US); Kaushik Mallick, Thornton, CO (US); Jake Schrader, Westminster, CO (US); John Cronin, Lakewood, CO (US); Andrew Coors, Morrison, CO (US)

(73) Assignee: STEELHEAD COMPOSITES, INC., Golden, CO (US)

(21) Appl. No.: 17/384,630

(22) Filed: Jul. 23, 2021

(51) Int. Cl. F17C 1/16

(52) U.S. Cl. CPC F17C 1/16; F17C 2205/0305; F17C 2203/0604; F17C 2203/066; F17C 2221/012; F17C 2270/0184

(57) ABSTRACT

The present invention discloses a boss configuration for a Type IV composite pressure vessel (“CPV”). In particular, the invention provides liner-to-boss interface that allows the polymeric liner to wrap around the internal collar of the boss that extends below the flange. Since the wrap-around section of the liner conforming to the internal collar portion of the boss is subjected to pressure from all sides, the liner stays adhered to the boss when the inside surface of the liner in a CPV is subjected to internal pressure from the contained fluid.

### FIELD OF THE INVENTION

The present invention relates to a boss configuration for a Type IV composite pressure vessel (“CPV”). In particular, the invention provides a liner-to-boss interface that allows the polymeric liner to wrap around an internal collar of the boss that extends below the flange, thereby significantly enhancing the effectiveness of the interface. The wrap-around section of the liner conforming to the internal collar portion of the boss is subjected to pressure from all sides, thereby allowing the liner to stay adhered to the boss when the inside surface of the liner in a CPV is subjected to internal pressure from the contained fluid.

### BACKGROUND OF THE INVENTION

Pressure vessels are used in a variety of applications and come in a variety of types and materials. Depending on the materials used in construction, pressure vessels are currently classified in five different categories, i.e., Types I-V. Type IV CPVs that use lightweight polymeric liners have been of great interest recently, particularly for use in automobiles, heavy duty trucks, busses and locomotives where light weight pressure vessels are needed to contain pressurized gases such as Hydrogen that drive fuel cell propulsion.

While their light weight construction provide a significant fuel or energy savings, the materials used in constructing Type IV CPVs may potentially result in a higher rate of failure or breakage. This is especially true in areas of interface where the polymeric liner is joined or mated to a polar boss made of a dissimilar material.

Therefore, there is a need for Type IV CPVs that are designed to eliminate or significantly reduce leak path or potential failure at the interface between the liner and the boss through the life cycle of the CPV.

### SUMMARY OF THE INVENTION

Some aspects of the invention are based on a discovery by the present inventors that a boss design that includes an internal collar portion in Type IV CPVs eliminates or significantly reduces failure rates observed in conventional Type IV CPVs. In particular, the boss design of the present invention includes an internal collar portion that allows the liner of Type IV CPVs to wrap-around the boss collar, thereby subjecting the pressure created by the internal fluid on all sides of the interface between the boss and the liner.

One particular aspect of the invention provides a boss (10) that is designed to eliminate or at minimum significantly reduce a failure rate observed in conventional Type IV CPVs. The boss (10) of the invention includes:
a tubular neck (100) with a longitudinal axis;
an outer surface (104);
an inner surface (108);
an annular flange (200) extending radially from said tubular neck (100) and comprising:
   a top surface (204), and
   a bottom surface (208);
an external collar portion (300) located on said top surface (204) of said annular flange (200) comprising:
   an external surface (304); and
   an internal surface (308) adapted for attaching an optionally removable valve or an adapter; and
an internal collar portion (400) located on said bottom surface (208) of said annular flange (200) comprising:
   an external surface (404), and
   an inner surface (408).

In some embodiments, the inner surface (108) comprises an annular recessed portion (112). Yet in other embodiments, the external surface (404) comprises at least one annular groove (412).

Still in other embodiments, said bottom surface (208) of said annular flange (200) further comprises at least one groove (212). In certain embodiments, said groove (212) on said bottom surface (208) of said annular flange (200) is an annular groove. In other embodiments, said bottom surface (208) of said annular flange (200) comprises a plurality of said grooves (212).

Another aspect of the invention provides a pressure vessel comprising: (i) a liner (500) made from a material comprising a polymer, wherein said liner (500) comprises an aperture for fluid (e.g., liquid and/or gas) interface, (ii) a boss (10) coupled to said aperture (504) of said liner (500), and (iii) a reinforcing layer of a composite material (600) overwrapping said liner (500) and at least a portion of said boss (10), wherein said boss (10) comprises:
a tubular neck (100) with a longitudinal axis, wherein said aperture of said liner is coaxial to said tubular neck (100);
an outer surface (104);
an inner surface (108);
an annular flange (200) extending radially from said tubular neck (100) and comprising:
   a top surface (204) that is at least partially overwrapped with said composite material (600), and
   a bottom surface (208) that interfaces with or mated to said liner (500);
an external collar portion (300) located on said top surface (204) of said annular flange (200) comprising:
   an external surface (304); and
   an internal surface (308) adapted for attaching an optionally removably valve, a fitting, or an adapter; and
an internal collar portion (400) located on said bottom surface (208) of said annular flange (200) comprising:
   an external surface (404); and
   an internal surface (408); and
wherein said liner has contours that mate with (i) said external surface (404) of said internal collar portion (400) and (ii) at least a portion of said internal surface (408) of said internal collar portion (400).

In some embodiments, the liner has contours that mate with at least a portion of said inner surface (108) or with at least a portion of said inner surface (308) of said external collar portion (300).

Yet in other embodiments, said inner surface (108) comprises an annular recessed portion (112) that may be used to terminate the polymeric liner. In certain embodiments, said liner (500) has contours that mate with said annular recessed portion (112).

Still in other embodiments, said external surface (404) comprises at least one annular groove (412). In certain embodiments, said liner has contours that mate with said annular groove (412).

In further embodiments, said bottom surface (208) of said annular flange (200) further comprises at least one groove (212). In some instances, said groove (212) on said bottom surface (208) of said annular flange (200) is an annular groove. Yet in other embodiments, said bottom surface (208) of said annular flange (200) comprises a plurality of said grooves (212). In other embodiments, said liner has contours that mate with said groove (212) on said bottom surface (208) of said flange (200).

Yet in other embodiments, said annular flange (200) further comprises a bore (216). In some instances, said annular flange (200) further comprises a plurality of bores (216). It is believed that when bore(s) (216) are present in the annular flange (200), the liner (500) flows into bore(s) (216) and provide further means of securing said boss (100) to liner (500). In certain instances, said liner has contours that mate with said bore (216) on said flange (200).

Still in other embodiments, said liner (500) is mated to said boss (10) by a co-molded polymer-boss connection zone.

In further embodiments, said inner surface (108) comprises an annular recessed portion (112). Yet in other embodiments, said liner (500) has contours that mate with said annular recessed portion (112). Still in other embodiments, said liner (500) mates with a portion of said inner wall (408).

### BRIEF DESCRIPTION OF THE DRAWINGS

FIG. 1A is a cross-sectional view of one embodiment of a boss of the present invention.

FIG. 1B is a cross-sectional view of the boss of FIG. 1A that includes a plurality of groove (212) on the bottom surface (208) of the annular flange (200).

FIG. 2A is a cut away view of a liner combined with the cross-section view of FIG. 1A showing pressure exerted by the internal fluid contained in the liner.

FIG. 2B is another cut away view of a liner combined with the cross-section view of FIG. 1A showing various components and internal pressure exerted by fluid medium.

FIG. 3A is a cross-section view showing how liner (500) is connected to boss (10) of the invention that is fitted with a valve, adapter, or a fitting. Alternate embodiments may not have seal (704B), but would have seal (704A) at the boss only.

FIG. 3B is a cross-section view of a Type IV composite pressure vessel showing composite overwrap and without a seal (704B).

FIG. 4 is a bottom perspective view of one embodiment of boss (10) with a hexagonal collar optionally having a plurality of bores (216).

FIG. 5A is a bottom perspective view of one embodiment of boss (10) with a slot collar design.

FIG. 5B is a bottom direct view of boss of FIG. 5A.

FIG. 6 is bottom perspective view of boss (10) having spoked internal collar design.

### DETAILED DESCRIPTION OF THE INVENTION

Type IV pressure vessels are much lighter weight than other pressure vessel types (e.g., Types I-III) because they use polymeric liner, as opposed to metal, overwrapped with composite material. In applications where reducing overall mass is important, e.g., in transportation such as automobiles, airlines, locomotives, marine transportation etc., Type IV pressure vessels allow a significant weight reduction in storing pressurized gas. Accordingly, demands for Type IV CPVs have increased significantly recently. However, it should be noted that pressure vessels can be dangerous if it fails in service, and fatal accidents have occurred in the history of their development and operation. Consequently, pressure vessel design, manufacture, and operation are regulated by engineering authorities backed by legislation.

Design of pressure vessels involves various parameters and considerations, such as maximum safe operating pressure and temperature, safety factor, corrosion allowance and minimum design temperature. While considerable advances have been made in Type IV CPVs that employ polymeric liners, one area of engineering merit is the interface between a liner and a boss. Conventional Type IV CPVs face limitations when operating under great internal pressure due to poor interface of the polymeric liner and the boss subjected to repeated cycles. It is believed that a good interface between the liner and the boss is critical to the functionality, leak tightness and long life of Type IV CPVs.

The present inventors have discovered that by designing a boss with a wrap-around section of the liner conforming to the boss collar allows the interface of the liner and the boss to be subjected to pressure from all sides, thereby allowing the liner to stay mated or adhered to the boss when the inside surface of the liner in a CPV is subjected to internal pressure from the contained fluid.

A typical Type IV pressure vessel of the present invention includes a thermoplastic liner which substantially defines a pressure chamber within the vessel. A polar region of the liner has a pressure chamber orifice placed in fluid communication with the pressure chamber. Two thermoplastic collars which are rigid homogeneous extensions of the liner extend along longitudinal collar axes parallel to the pressure chamber orifice. Each stud is preferably circular but may also be ovoid or utilize other cross-sectional geometries transverse to the stud axis. The vessel also includes a metal boss having a neck and a flange secured to the neck. The flange may be an integral extension of the neck. The neck is aligned with the pressure chamber orifice so that a passage in the neck provides fluid communication between the pressure chamber and the environment outside the vessel.

The design covered by this invention can also allow for direct sealing or mating of the fluid interface appurtenance (e,g., a valve or a fitting 700) with the metallic part of the polar boss in the liner. In contrast to most conventional Type IV CPVs, devices of the invention allow metal-to-metal seal (i.e., between boss and a valve or a fitting), thereby reducing or eliminating some of the problems associated with conventional Type IV CPVs, such as deterioration of the plastic collar adjacent to the primary seal between the fitting and the boss. One or two o-rings or other annular seals (704A and 704B) can be present between the inner surface (108) of the boss and the valve or a fitting (700), which can be removably attached to the fitting (700).

Some of the methods that can be used in producing the liners of Type IV CPVs of the invention include, but not limited to rotational molding, blowmolding, injection molding, rotocasting, reactive rotomolding, spray forming, as well as other methods known to one skilled in the art for producing Type IV CPVs.

The present invention will be described with regard to the accompanying drawings, which assist in illustrating various features of the invention. In this regard, the present invention generally relates to a boss, in particular a polar boss for Type IV CPVs and a pressure vessel comprising said boss that provides the interface for fluid management outside of the CPV. In particular, some aspects of the invention relates to a polar boss and a liner for Type IV CPVs comprising said polar boss. For the sake of clarity and brevity, the present invention will now be described in reference to a polar boss and Type IV CPVs comprising said polar boss. However, it should be appreciated that the scope of the invention is not limited to merely polar boss and Type IV CPVs. In fact, methods and devices of the invention can be used generally in any CPVs where a boss is used with a liner made from a material comprising a polymer. Discussion on a polar boss of the invention and Type IV CPVs comprising said polar boss is provided solely for the purpose of illustrating the practice of the invention and do not constitute limitations on the scope thereof.

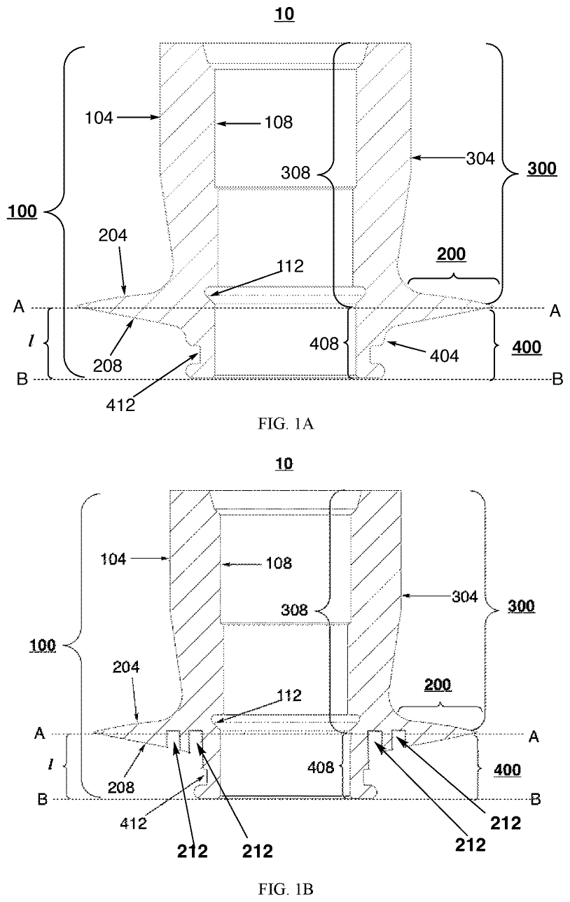

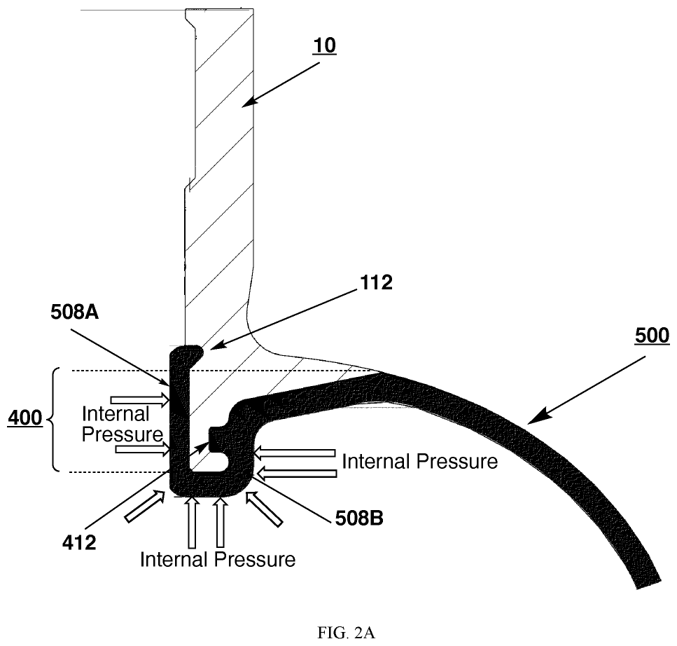

Referring to FIGS. 1A-6, the present invention relates to a boss (10). In some embodiments, a polar boss for Type IV CPVs is provided. The boss (10) of the invention includes a tubular neck (100) with a longitudinal axis. The boss (10) also includes an outer surface (104), an inner surface (108), and an annular flange (200) extending radially from said tubular neck (100). The annular flange (200) includes a top surface (204), and a bottom surface (208). The tubular neck (100) is divided into two different portions or sections, namely, an external collar portion (300), e.g., a portion above the plane A-A, and an internal collar portion (400) a portion below the plane A-A. One of the key advantages of the invention is the presence of the internal collar portion (400). Without being bound by any theory, it is believed that as illustrated in FIG. 2, during the operation, the internal collar portion (400) allows the internal fluid to exert pressure on all sides (508A and 508B as well as the bottom portion) of the liner that is mated with the internal collar portion (400), thereby further preventing any potential for detachment or segregation of the boss (10) from the liner (500) resulting in a leak or failure of the CPV.

The external collar portion (300) is generally located on said top surface (204) of said annular flange (200) and comprises: an external surface (304); and an internal surface (308) adapted for attaching an optionally removable valve, a fitting, or an adapter.

The internal collar portion (400) is located on the bottom surface (208) or below the A-A plane of said annular flange (200). The internal collar portion includes an external surface (404), and an internal surface (408). In some embodiment, the external surface (404) comprises at least one annular groove (412).

FIGS. 2A and 2B show a cut-away view of a Type IV pressure vessel comprising: (i) a liner (500) with a boss (10) of the invention coupled thereto. For clarity, reinforcing layer of a composite material (600) is omitted. Typically, the reinforcing composite material (600) overwraps the entire liner (500) and at least a portion of annular flange (200). One of the key features of the invention is illustrated by the pressure arrows in FIGS. 2A and 2B. Unlike conventional boss, boss (10) of the invention includes internal collar portion (400). The presence of this internal collar portion (400) results in the liner-to-boss interface countering internal pressures (as indicated by opposing horizontal arrows). Such countering of the internal pressure that surrounds the interface prevents or significantly reduces the likelihood of detachment of boss (10) from the liner (500) under repeated pressure cycles desirable for a Type IV pressure vessel.

Typically, the length l, i.e., depth or height of internal collar portion (400), see FIG. 1A, ranges from about 0.2 cm to about 10 cm, typically from about 0.2 cm to about 5 cm, often from about 0.2 cm to about 2.5 cm, and more often from about 0.2 cm to about 2 cm. In one particular embodiment, the length l is from about 0.5 cm to about 2 cm. However, it should be appreciated that the scope of the invention is not limited to these particular range of length l. In general, the internal collar portion (400) can be of any length as long as it is sufficiently long such that the pressure exerted by the fluid within liner (500) is effective in allowing the interface between the liner (500) and the boss (10) to survive pressure cycles typical of the CPV's operating conditions.

In some embodiments, the external surface (404) of internal collar portion (400) includes an annular ring (412). In some embodiments (not shown), there are a plurality of annular rings (412) within the external surface (404) of internal collar portion (400). The presence of such annular ring (412) provides a mechanical lock between the liner and the polar boss, thereby improving the interface between the boss (10) and the liner (500) under repeated pressure cycles.

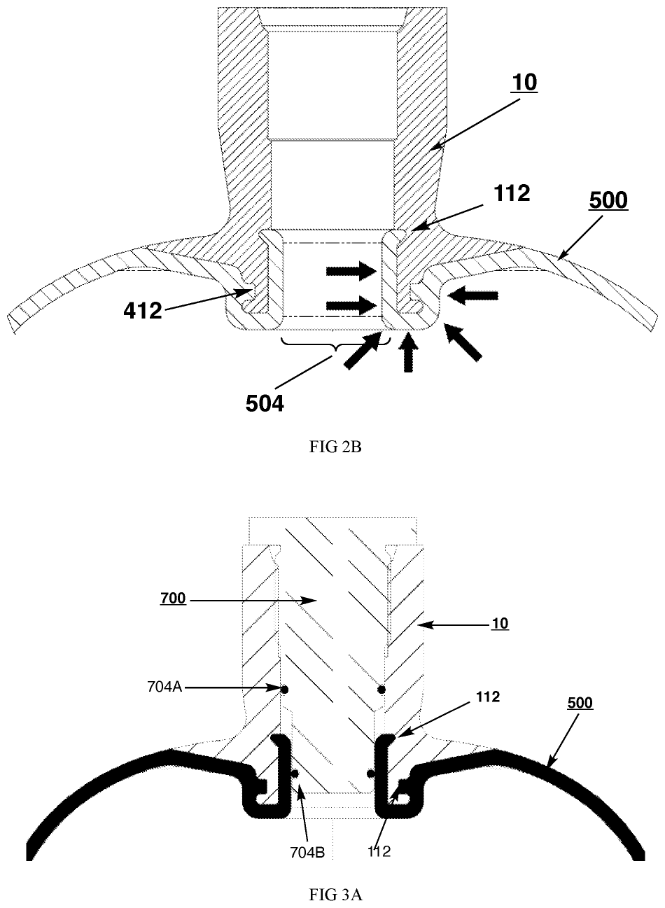

FIG. 3A and FIG. 3B show a Type IV pressure vessel configuration using boss (10) of the invention fitted with a fitting or a valve (700). As can be seen, the pressure vessel of the invention includes a thermoplastic liner (500) which substantially defines a pressure chamber within the vessel. A polar region of the liner (500) has a pressure chamber orifice placed in fluid communication with the pressure chamber. Two thermoplastic collars which are rigid homogeneous extensions of the liner extend along longitudinal collar axes parallel to the pressure chamber orifice. Each collar is preferably circular but may also be ovoid or utilize other cross-sectional geometries transverse to the collar axis. The vessel also includes a metal boss (10) having a neck and a flange secured to the neck. The flange may be an integral extension of the neck. The neck is aligned with the pressure chamber orifice so that a passage in the neck provides fluid communication between the pressure chamber and the environment outside the vessel. As can be seen in FIGS. 2A-2B and 3A-3B, the liner (500) is contoured to be mated with the boss (10) such that horizontal internal pressure (FIGS. 2A and 2B) exerted by the fluid within the liner (500) prevents the liner from getting detached from the polar boss. Such internal pressure along with the groove (412), FIG. 1A, help the boss (10) to remain in position with respect to the liner (500). In some embodiments, an annular recessed portion (112), see FIGS. 1A, 1B, 3A, and 3B, can be present within the inner surface of the boss (10). The annular recessed portion (112) can be present within the inner surface of either the external collar portion (300) or the internal collar portion (400) of boss (10). The liner (500) can be contoured to be mated with the annular recessed portion (112) to provide additional fixation of the boss (10) within the liner (500).

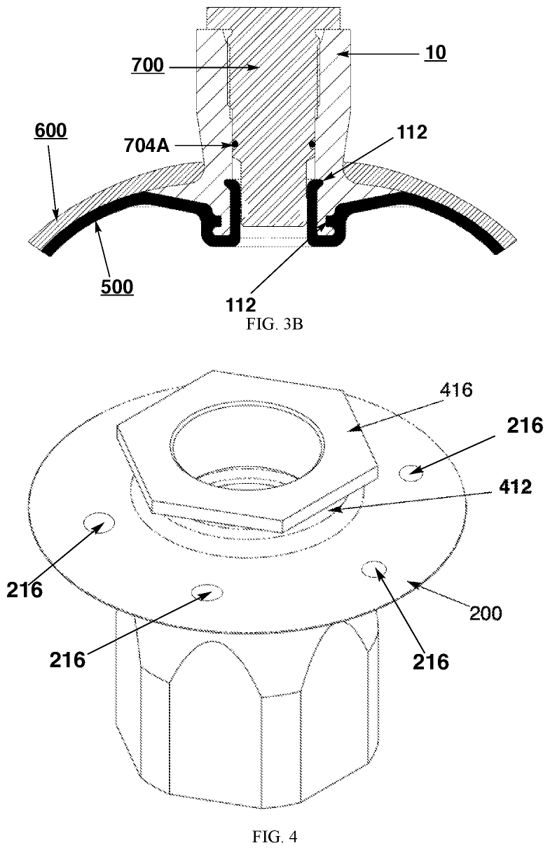

Referring again to FIG. 3A, the valve or fitting (700) can include a primary o-ring/seal (704B) in addition to a secondary o-ring/seal (704A) to prevent leakage of fluid and/or to encourage the valve or fitting (700) to provide a leak-free interface to the boss (10) while allowing communication with devices external to the CPV. The o-ring or the seal can be placed within an annular groove (not shown) that may be present in the boss (10) or the fitting or valve (700). In some embodiments, liner (500) is contour mated with boss (10) such that boss (10) cannot be moved once it is positioned within liner (500). See, for example, FIGS. 4-6.

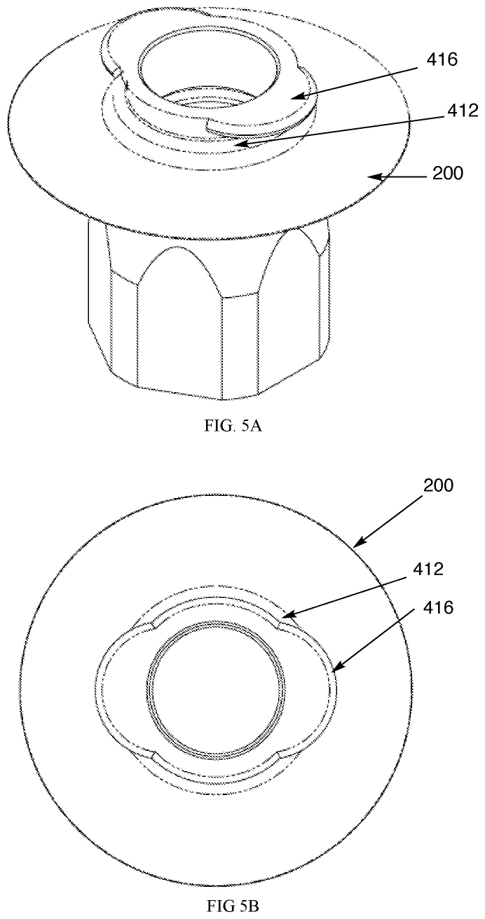

To further prevent failure or displacement of boss (10) from liner (500), internal collar portion (400) can include other configurations as illustrated in FIGS. 4-6. For example, the bottom portion (416) of internal collar portion in FIG. 4 is hexagonally shaped with the annular groove (412) that is present between the bottom protrusion (416) and the flange (200). In FIGS. 5A and 5B, the bottom portion or the protrusion (416) is in a wing or a flange configuration with the annular groove (412) also being present between the bottom protrusion (416) and flange (200).

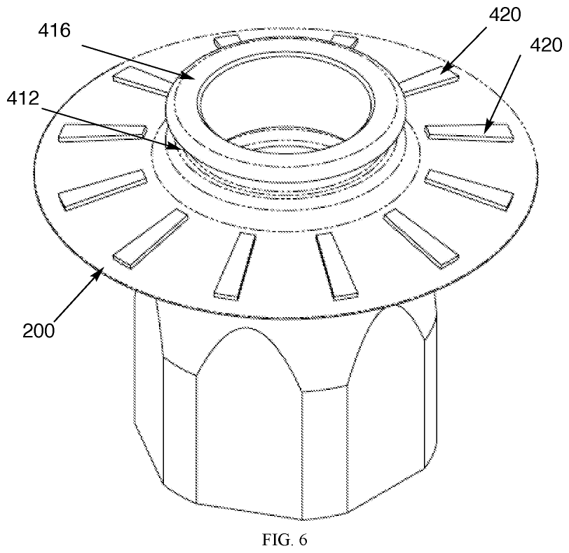

FIG. 6 is another embodiment of boss (10) of the invention. In this configuration, bottom portion (416) is a small flange with annular groove (412) being present between the bottom portion (416) and the boss flange (200). In FIG. 6, element 420 that is present within flange (200) can be protuberance and/or orifice. When element 420 is an orifice, liner (500) will be contour mated such that liner material will fill the orifice. When element 420 is protuberance, liner (500) will be contour mated such that the liner material will have depressions to fixate protuberances 420.

As can be seen, a wide variety of configurations of inner collar portion (400) of boss (10) are within the scope of the invention. FIGS. 1-6 are provided solely for the purpose of illustrating the practice of the present invention and do not constitute limitations on the scope thereof.

The invention is particularly useful for Type IV composite pressure vessels. Specifically, it relates to polymer lined composite pressure vessels (CPVs), where the polymeric liner is overwrapped with composite materials that acts as the structural shell to hold the internal pressure of the contained fluid. The polymeric liner acts as a permeation barrier for the internal fluids. The liner may be fitted on one or both ends with polar boss(es) that allows for fluid interface with devices external to the CPV. The polymeric liner may be made out of plastics such as high density polyethylene (HDPE), cross-linked high density polyethylene (XLPE), polyamides (such as Nylon of grade PA-6, PA-11 etc), polyimides, Teflon (PTFE), Tefzel, Kynar, etc. Generally, any polymeric material known to one skilled in the art can be used. The polymer liner may also be made out of elastomeric material such as rubber. The polar boss may be made out of metal, metal alloy, polymer, ceramic, composite material, or any other materials that are well known to one skilled in the art.

The liner can be fabricated by many plastic processing methods, including techniques such as rotomolding. In rotomolding method, plastic pellets are inserted inside a closed mold that holds the boss and the mold is rotated around multiple axes while it is subjected to high temperature inside an oven. The temperature allows the plastic pellets to melt and stick to the mold wall as well as the inside surface of the boss. When melting is complete, fully forming the liner wall, the mold is removed from the heated chamber and allowed to cool. The liner and the boss assembly is removed from the mold at the end of the process.

In an alternative process, the liner can be made using ‘reactive rotomolding’ where liquid chemicals are injected inside a closed mold that is rotated around multiple axes. The reactive chemicals along with catalysts can initiate a chemical reaction that form the polymer chains and allow the liner wall to build up layer at a time. In one specific example, the reactive chemicals can be caprolactum that forms polyamide (PA6) as the finished and cured polymer for the liner.

In another alternative process called blowmolding, a semi-melted plastic shape, called a parison is inserted between two halves of a closed mold and the inside is pressurized against the mold wall to form the final shape of the liner. In this method, the boss may be integrated with the liner mold to allow for a liner and boss assembly to be harvested during the process. Alternatively, a polymeric liner alone may be formed by the blowmolding process and the boss can be fitted to the liner as a secondary operation.

The current invention can be used to make a liner and polar boss assembly in a multitude of plastic forming processes not limited to rotomolding or blowmolding process.

As discussed herein, one of the key features of the invention relates to polymeric liner-to-boss interface. In particular, it centers on how the polymeric part of the liner is allowed to wrap around the internal collar of the boss that extends below the flange and towards the inside of the liner or vessel. Since the wrap-around section of the liner conforming to the boss collar is subjected to pressure from all sides (see FIGS. 2A and 2B), this allows the liner to stay adhered to the boss when the inside surface of the liner in a CPV is subjected to internal pressure from the contained fluid. The pressure from the internal fluid is sealed off from extending through the boss throat or orifice by the radial seal(s) between the valve or the fitting and the boss.

The polymeric liner of a CPV is significantly less stiff than the composite shell. Consequently, it can stretch in all directions as the vessel expands with internal pressure and as it conforms to the composite shell. Depending on the design of the pressure vessel, the polymeric liner may be required to move freely relative to the boss flange or it may need to be bonded to the boss flange. In the former case, the underside of the boss may be treated using specialty chemicals such that the polymer does not form any mechanical bond with or adhesion to the metallic surface. In the latter case, the underside of the boss can be treated with reactive agents prior to the molding process that facilitates chemical bond between the boss and the liner. In another case, the underside of the boss can be sand blasted, knurled or mechanically roughened to allow for good mechanical bond between the liner and the boss. In another variation of this case, the underside of the boss flange may contain one or multiple grooves that allow for the liner material to be hooked and mechanically attached to the boss.

In one particular embodiment, the inside surface of the internal collar of the boss can be a machined with threads to allow for mechanical attachment between the boss and the liner. In another embodiment, the inside surface of the internal collar of the boss can be sand-blasted, knurled or mechanically roughened to allow for good mechanical bond between the liner and the boss. This mechanical bond is required to prevent the fluid peeling the liner from the boss when the interface is subjected to internal pressure of the CPV.

In another embodiment of the invention (e.g., FIG. 3A), the pressure of the internal fluid can be sealed off by a primary radial seal (704B) between an adapter, a valve or a fitting (700) and the liner (500) attached to the inside surface of the internal collar of the boss. A secondary seal (704A) between the adapter (700) and the boss (10) may or may not be used. In some embodiments, the adapter can be integral to the CPV construction such that it does not detach from the CPV. The adapter can also be designed to host an external valve that mates with the fluid interface external to the CPV.

Still in other embodiments, softer profile of the groove consisting of generous fillet radii at the corners is provided in the internal collar (112) to discourage any significant stress riser in the attachment between the liner and the outside circumference of the internal collar portion. In other embodiments, such profile of the groove allows for the liner on the inside circumference of the internal collar to be tucked inside a protective groove (e.g., 112) to avoid peeling off.

Yet in other embodiments of the invention (e.g., FIGS. 4-6), mechanical features are introduced in the boss to discourage or prevent relative rotation of the polar boss and the composite overwrap. This feature is important for the CPV to pass a key performance test that requires the boss to be torqued relative to the structural body (liner and composite). In one variation (e.g., FIG. 4) the mechanical feature prevents relative motion between the external collar of the boss and the composite overwrap around the neck of the boss. In other variations (e.g., Slot design, Spokes design and Bottom Hex), the boss is designed with integral features that prevent relative motion between itself and the liner. When the liner is chemically or mechanically bonded to the composite overwrap, these features also prevent a relative motion between the boss and the composite overwrap.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

1. A boss (10) adapted for use in a Type IV composite pressure vessel, wherein said boss consisting of:
a tubular neck (100) with a longitudinal axis;
an outer surface (104);
an inner surface (108) comprising an annular recessed portion (112);
an annular flange (200) extending radially from said tubular neck (100) and comprising:
a top surface (204), and
a bottom surface (208);
an external collar portion (300) located on said top surface (204) of said annular flange (200) comprising:
an internal surface (304) adapted for attaching an optionally removable valve or an adapter, and
an external surface (308); and
an internal collar portion (400) located on said bottom surface (208) of said annular flange (200) comprising:
an internal surface (404), and
an external surface (408) comprising at least one annular groove (412).

2. The boss (10) of claim 1, wherein said bottom surface (208) of said annular flange (200) further comprises at least one groove (212).

3. The boss (10) of claim 2, wherein said groove (212) on said bottom surface (208) of said annular flange (200) is an annular groove.

4. The boss (10) of claim 2, wherein said bottom surface (208) of said annular flange (200) comprises a plurality of said grooves (212).

5. A pressure vessel consisting of: (i) a liner (500) made from a material comprising a polymer, wherein said liner comprises an aperture (504), (ii) at least one boss (10) coupled to said aperture (504) of said liner (500), and (iii) a reinforcing layer of a composite material (600) externally formed around said liner (500) and at least a portion of said boss (10), wherein said boss (10) comprises:
a tubular neck (100) with a longitudinal axis, wherein said aperture of said polymeric liner is coaxial to said tubular neck (100);
an outer surface (104);
an inner surface (108) comprising an annular recessed portion (112), wherein said aperture of said liner has contours that mate with said annular recessed portion (112); an inner surface (108), wherein said liner has contours that mate with at least a portion of said inner surface (108);
an annular flange (200) extending radially from said tubular neck (100) and comprising:
a top surface (204) that is at least partially overwrapped with said composite material, and
a bottom surface (208) that interfaces with said liner, wherein said bottom surface optionally comprises at least one annular groove (212);
an external collar portion (300) located on said top surface (204) of said annular flange (200) comprising:
an internal surface (304) adapted for optionally removably attaching a valve or an adapter, and
an external surface (308); and
an internal collar portion (400) located on said bottom surface (208) of said annular flange (200) comprising:
an internal surface (404); and
an external surface (408),
wherein said liner has contours that mate with said external surface (408) and at least a portion of said internal surface (404) of said internal collar portion (400).

6. The pressure vessel of claim 5, wherein said external surface (408) comprises at least one annular groove (412), and wherein said liner has contours that mate with said annular groove (412) of said external surface (408).

7. The pressure vessel of claim 5, wherein said bottom surface (208) of said annular flange (200) further comprises at least one groove (212).

8. The pressure vessel of claim 7, wherein said groove (212) on said bottom surface (208) of said annular flange (200) is an annular groove.

9. The pressure vessel of claim 7, wherein said bottom surface (208) of said annular flange (200) comprises a plurality of said grooves (212).

10. The pressure vessel of claim 7, wherein said liner has contours that mate with said groove (212) on said bottom surface (208) of said flange (200).

11. The pressure vessel of claim 5, wherein said annular flange (200) further comprises a bore (216).

12. The pressure vessel of claim 11, wherein said annular flange (200) further comprises a plurality of bores (216).

13. The pressure vessel of claim 11, wherein said liner has contours that mate with said bore (216) on said flange (200).

14. The pressure vessel of claim 5, wherein said liner is joined to said boss by a co-molded polymer-boss connection zone.

15. (canceled)

16. The pressure vessel of claim 15, wherein said liner (500) contour mates with said annular recessed portion (112).
